(19) United States
(12) Patent Application Publication
(10) Pub. No.: US 2025/0256547 A1
(43) Pub. Date: Aug. 14, 2025

(54) HVAC MODULE INCLUDING A FILTER AND AN AIR FUNNEL

(71) Applicant: MAHLE International GmbH, Stuttgart (DE)

(72) Inventors: Edward Wolfe, Clarence Ctr., NY (US); Bailey Reid, Lockport, NY (US); Steve Zielinski, North Tonawanda, NY (US); Richard Baranowski, Lake View, NY (US); Debashis Ghosh, Amherst, NY (US)

(21) Appl. No.: 18/440,485

(22) Filed: Feb. 13, 2024

(51) Int. Cl. B60H 1/00; B60H 3/06

(52) U.S. Cl. CPC B60H 1/00471; B60H 3/0608

(57) ABSTRACT

A blower assembly for a heating, ventilation, and air conditioning (HVAC) module may include a blower and an air funnel. The blower may include a blower wheel. The air funnel may include a base portion and a circumferential wall connected to and projecting from the base portion. When viewed in a first direction parallel to a blower axis, a first flow area may be defined by and between a first side of the base portion and an outer perimeter of the blower wheel. When viewed in the first direction, a second flow area may also be defined by and between a second side of the base portion and the outer perimeter of the blower wheel.

### TECHNICAL FIELD

The present disclosure generally relates to heating, ventilation, and air conditioning (HVAC) modules that may, for example, be used in connection with vehicles.

### BACKGROUND

Vehicles commonly have HVAC systems and/or modules for controlling the climate within the vehicle cabin or another internal space and/or area of the vehicle by providing heated air and/or cooled air into the vehicle cabin. Some HVAC system and/or module designs include an air filter and an air funnel. During operation, a first flow of air passes through the air filter and into the air funnel in a vertical direction, while a second flow of air passes through the air filter and into a flow space in the vertical direction. The flow space is disposed outside of the air funnel and adjacent to the air funnel in a width direction extending transversely (e.g., perpendicular) to the vertical direction. A dimension/length of the inlet of the air funnel and a dimension/length of the air filter extending in a length direction, which is transverse (e.g., perpendicular) to the vertical direction and the width direction), are typically the same and/or equal to one another. It was thought that the inlet of the air funnel and the air filter needed to have the same length to ensure adequate sealing between the air filter and the air funnel.

However, computational fluid dynamics (CFD) has revealed that there are drawbacks and challenges with these HVAC system and/or module designs. For example, when the inlet of the air funnel and the air filter have the same length a restriction of airflow occurs in a region near, adjacent to, and/or at or about a region where air exits from the scroll portion of the housing (e.g., into a branch portion of the housing). This not only reduces efficiency of the HVAC system and/or module and/or efficiency of the fan and/or blower thereof, it also results in the generation of undesirable noise during operation.

Accordingly, there is a need for an improved HVAC system and/or module that minimizes or eliminates one or more challenges or shortcomings of existing HVAC systems and/or modules.

### SUMMARY

A blower assembly for a heating, ventilation, and air conditioning (HVAC) module may include a blower and an air funnel. The blower may include a blower wheel. The air funnel may include a base portion and a circumferential wall connected to and projecting from the base portion. When viewed in a first direction parallel to a blower axis, a first flow area may be defined by and between a first side of the base portion and an outer perimeter of the blower wheel. When viewed in the first direction, a second flow area may also be defined by and between a second side of the base portion and the outer perimeter of the blower wheel.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of an exemplary HVAC module;

FIG. 2 is a perspective, partially exploded view of the HVAC module of FIG. 1;

FIGS. 3A and 3B are cross-sectional perspective views through a second valve of the HVAC module of FIG. 1 when the valves are each in a first position (FIG. 3A) and when the valves are each in a second position (FIG. 3B), respectively;

FIGS. 4A, 4B, and 4C are cross-sectional perspective views through a third valve of the HVAC module of FIG. 1 when the valves are each in the first position (FIG. 4A), when the valves are each in the second position (FIG. 4B), and when the first valve is in the first position, the second valve is in the second position, and the third valve is in an intermediate position (FIG. 4C), respectively;

FIG. 5A is a cross-sectional perspective front view of the HVAC module of FIG. 1 when the valves are each in the first position;

FIG. 5B is a cross-sectional perspective rear view of the HVAC module of FIG. 1 when the valves are each in the second position;

FIG. 6 is a cross-sectional side view of the HVAC module of FIG. 1; and

FIG. 7 is a partial view of the blower assembly of the HVAC module of FIG. 1 with the second housing shell hidden.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

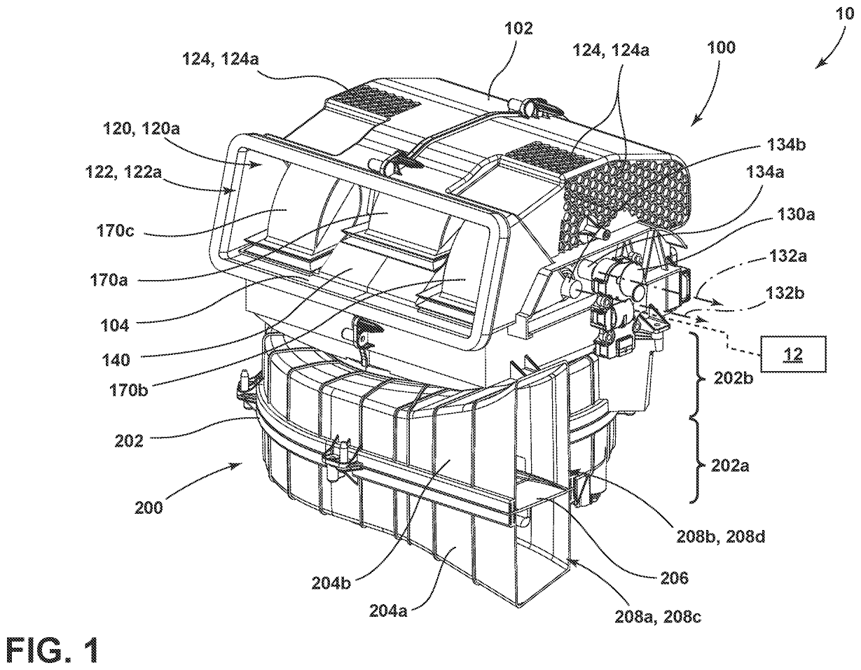

FIGS. 1-5B present a heating, ventilation, and air conditioning (HVAC) module 10 configured to receive air from one or more air sources (e.g., first and second air sources) and selectively output the received air, such as to one or more portions, areas (e.g., zones), and/or regions within a vehicle. Air (e.g., external air) from a first air source (e.g., an external space outside of the vehicle) may be considered and/or referred to as first input air 22. Air (e.g., recirculation air) from a second air source (e.g., an interior space and/or cabin of the vehicle) may be considered and/or referred to as second input air 32.

As generally illustrated in FIG. 1, the HVAC module 10 includes a valve assembly 100, a blower assembly 200, and a controller 12. The valve assembly 100 and the blower assembly 200 are connected to one another and are in fluid communication with one another. The valve assembly 100 is configured to receive air 22, 32 from one or more air sources and selectively communicate the received air 22, 32 to the blower assembly 200 (e.g., as a first airflow 40 and/or as a second airflow 50). The blower assembly 200 is configured to receive air (e.g., the first airflow 40 and/or the second airflow 50) from the valve assembly 100 and output that air to one or more structures, spaces, and/or destinations (e.g., as a first output air 42 and a second output air 52). The controller 12 is operatively connected (e.g., communicatively connected, electrically connected, and/or physically connected) to (i) the valve assembly 100 and/or one or portions/parts/elements thereof and (ii) the blower assembly 200 and/or one or portions/parts/elements thereof. The controller 12 is configured to control and/or operate the HVAC module 10, the valve assembly 100, and/or the blower assembly 200.

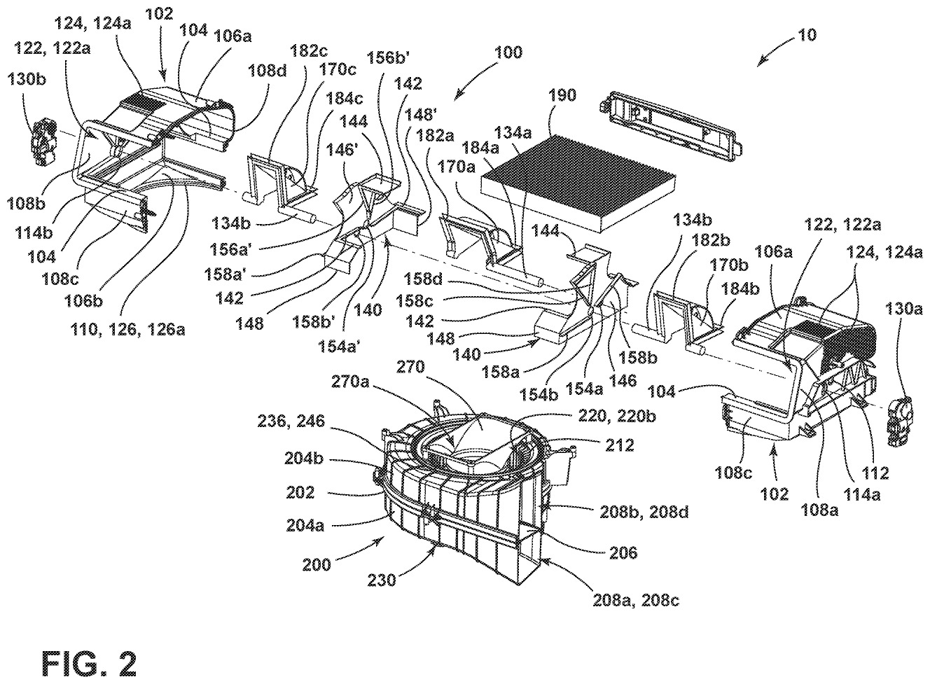

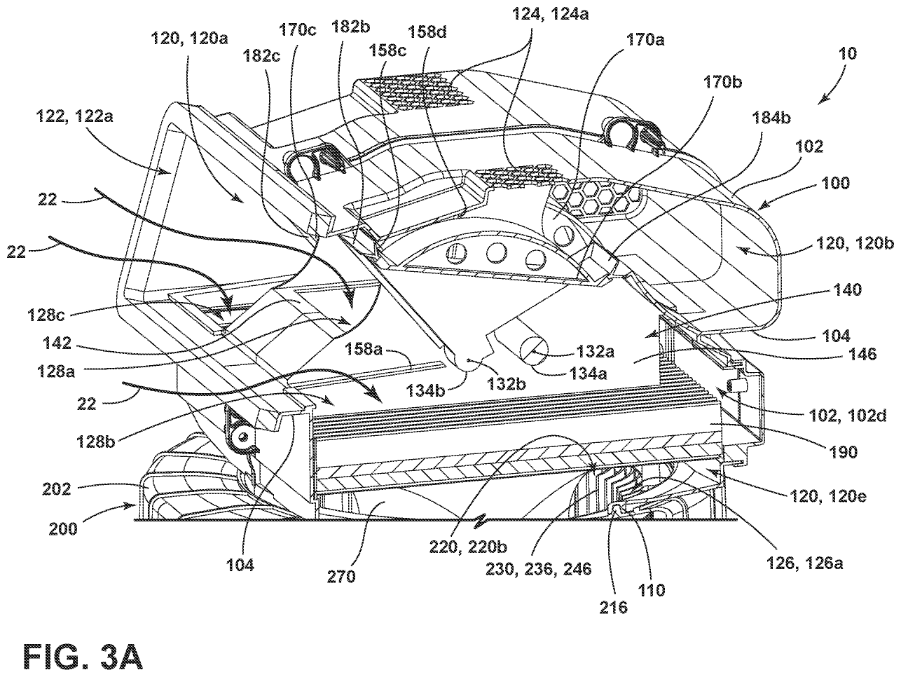

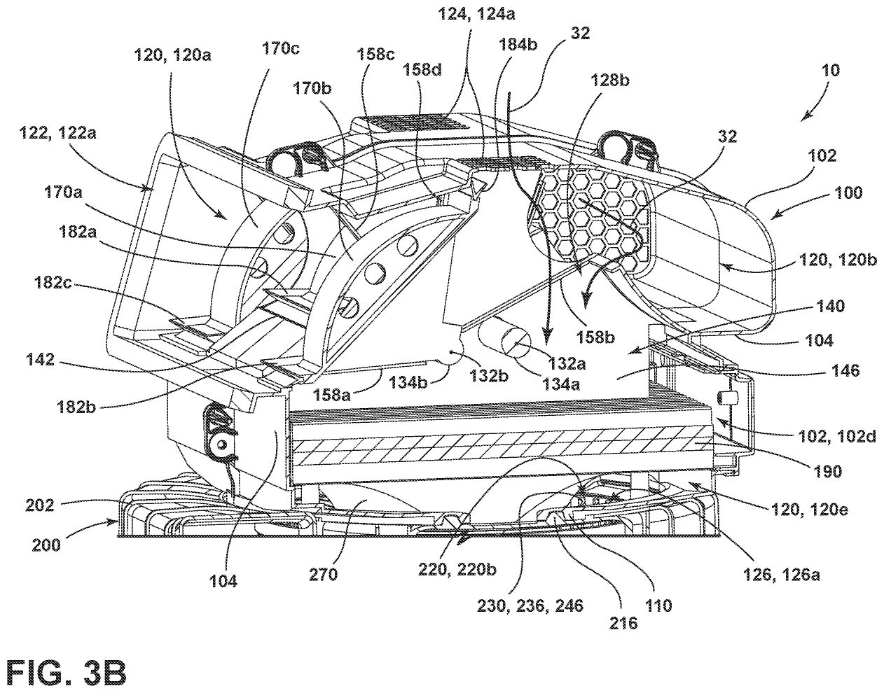

As generally illustrated in FIGS. 2-5B and described in further detail below, the blower assembly 200 includes a blower housing 202, a blower 230, and an air funnel 270. The valve assembly 100 includes a valve housing 102, a plurality of actuators and/or motors (e.g., a first and second actuator 130a, 130b), a plurality of shafts (e.g., a first and second shaft 134a, 134b), a plurality of valves (e.g., a first, second, and third valve 170a, 170b, 170c), and a filter 190. The valve housing 102 includes a plurality of air inlets (e.g., a first and second inlet 122, 124), an air outlet 126, and a plurality of airflow openings (e.g., a first, second, and third airflow opening 128a, 128b, 128c; see FIG. 3A). The valve housing 102 also includes a valve support 140 for supporting the valves 170a-170c and the shafts 134a, 134b within the valve housing 102. The valves 170a-170c and the filter 190 are arranged in an internal space 120 of the valve housing 102 (also referred to as the ‘valve housing internal space’ and/or ‘VH internal space’). The VH internal space 120 includes a first intake region 120a, a second intake region 120b, a first unfiltered region 120c, a second unfiltered region 120d, and a filtered region 120e. Air (e.g., first input air 22 and/or external air) from a first air source is flowable into the first intake region 120a via the first inlet 122. Air (e.g., second input air 32 and/or recirculation air) from a second air source is flowable into the second intake region 120b via the second inlet 124. The intake regions 120a, 120b are in selective fluid communication with (i) the first unfiltered region 120c via the first airflow opening 128a and (ii) the second unfiltered region 120d via the second and third airflow openings 128b, 128c. The first valve 170a is adjustable about a first axis 132a to selectively open and close the first airflow opening 128a with respect to the intake regions 120a, 120b. The second and third valves 170b, 170c are adjustable about a second axis 132b to selectively open and close the second and third airflow openings 128b, 128c, respectively, with respect to the intake regions 120a, 120b. The filter 190 is disposed between and/or separates (to at least an extent) the first unfiltered region 120c and an inner space 270a of the air funnel 270, which projects through the air outlet 126 and into the VH internal space 120. The filter 190 is also disposed between and/or separates (to at least an extent) the second unfiltered region 120d and the filtered region 120e. The funnel inner space 270a is in fluid communication with a first inner region 220a of an internal space 220 of the blower housing 202 (also referred to as the ‘blower housing internal space’ and/or ‘BH internal space’), which is in fluid communication with a first flow region 220c of the BH internal space 220 and a first outlet 208a of the blower housing 202. The filtered region 120e is in fluid communication with a second inner region 220b of the BH internal space 220 via the air outlet 126 of the valve housing 102 and an inflow opening 212 of the blower housing 202. The second inner region 220b is in fluid communication with a second flow region 220d of the BH internal space 220 and a second outlet 208b of the blower housing 202.

As generally illustrated in FIGS. 3A-5B, during operation of the HVAC module 10, air (e.g., first input air 22) flows into the first intake region 120a via the first inlet 122 and/or air (e.g., second input air 32) flows into the second intake region 120b via the second inlet 124. The first input air 22 in the first intake region 120a and/or the second input air 32 in the second intake region 120b flows through one or more of the airflow openings 128a-128c based on the positions of the valves 170a-170c. Air 22, 32 flowing through the first airflow opening 128a, which may be considered and/or referred to as a first airflow 40, flows into the first unfiltered region 120c, through the filter 190, and into the funnel inner space 270a (i.e., into the blower assembly 200). The first airflow 40 then flows sequentially through the funnel inner space 270a, the first inner region 220a, the first flow region 220c, and the first outlet 208a, at which point the first airflow 40 is output and/or expelled from the blower assembly 200 and/or the HVAC module 10 as first output air 42 that may ultimately be directed to one or more first destinations (e.g., a windshield defrost zone of a vehicle cabin). Air 22, 32 flowing through the second airflow opening 128b and air 22, 32 flowing through the third airflow opening 128c both flow into the second unfiltered region 120d and, thus, may be considered and/or referred to as a second airflow 50. The second airflow 50 then flows into the filtered region 120e by flowing through the filter 190, and subsequently flows into the second inner region 220b of the blower assembly 200 via the air outlet 126 of the valve housing 102 and the inflow opening 212 of the blower housing 202. The second airflow 50 then flows sequentially through the second inner region 220b, the second flow region 220d, and the second outlet 208b, at which point the second airflow 50 is output and/or expelled from the blower assembly 200 and/or the HVAC module 10 as second output air 52 that may ultimately be directed to one or more second destinations (e.g., one or more second/footwell zones of a vehicle cabin).

As generally illustrated in FIGS. 1-4C, the valve housing 102 defines a VH internal space 120 in which the valves 170a-170c and the filter 190 are arranged. The valve housing 102 includes a partition 104, a first end wall 106a, a second end wall 106b, and one or more sidewalls 108a-108d extending between and connecting the end walls 106a, 106b (see FIG. 2). The partition 104 is disposed between the end walls 106a, 106b. The partition 104 extends transversely to the sidewalls 108a-108d and projects from and/or is connected to the sidewalls 108a-108d.

As generally illustrated in FIGS. 1-4C, the valve housing 102 includes a plurality of air inlets via which air is flowable into the VH internal space 120. The plurality of air inlets includes a first inlet 122 (e.g., a fresh air inlet) via which first input air 22 (e.g., external air) from the first air source is flowable into the first intake region 120a. The first inlet 122 includes and/or is defined by a first inlet opening 122a, which is disposed in and defined by the valve housing 102.

The plurality of air inlets further includes a second inlet 124 (e.g., a recirculation air inlet) via which second input air 32 (e.g., recirculation air) from the second air source is flowable into the second intake region 120b. The second inlet 124 includes and/or is defined by a plurality of second inlet openings 124a, which are disposed in and/or defined by the valve housing 102 (e.g., the first end wall and/or one or more sidewalls). The valve housing 102 includes several subsets or groups of second inlet openings 124a. Each subset or group of second inlet openings 124a includes a plurality of second inlet openings 124a that are arranged in a closely packed array (e.g., a grid arrangement, a honeycomb arrangement) and defined by a region and/or section of the valve housing 102 that is structured in the manner of a mesh and/or lattice. Conceivably, the second inlet 124 may alternatively include and/or formed by a single second inlet opening 124a, a single subset or group of second inlet openings 124a, or in other suitable configurations.

As generally illustrated in FIGS. 2-5B, the valve housing 102 includes an air outlet 126 via which air (i.e., input air 22, 32 that has passed through the filter 190, the first airflow 40, and/or the second airflow 50) is expelled and/or flowable out of the valve housing 102. The air outlet 126 includes and/or is defined by an outlet opening 126a, which is disposed in and/or defined by the valve housing 102 (e.g., the second end wall 106b). The filtered region 120e and the second inner region 220b are in direct fluid communication with one another via the air outlet 126 and the inflow opening 212. The air funnel 270 is disposed partially in the air outlet 126 and extends into the VH internal space 120 via the air outlet 126. As such, the air outlet 126 and the inflow opening 212 enable fluid communication between the first unfiltered region 120c and the first inner region 220a via the air funnel 270.

As generally illustrated in FIGS. 2-5B, the valve housing 102 includes an attachment formation 110 configured to engage a complimentary attachment formation 216 of the blower housing 202 and at least partially attach and/or seal the valve assembly 100 (e.g., the valve housing 102) and the blower assembly 200 (e.g., the blower housing 202). The attachment formation 110 includes a plurality of protrusions (e.g., two protrusions) that define a channel that receives a complimentary projection of the attachment formation 216. The protrusions and the channel of the attachment formation 110 extend substantially parallel to one another and extend around and/or encircle the air outlet 126.

As generally illustrated in FIGS. 2-5B, the valve housing 102 further includes a valve support 140 arranged in the VH internal space 120. The valve support 140 is formed and/or defined by one or more separate components, structures, and/or elements connected to one or more other portions of the valve housing 102. Conceivably, the valve support 140 and/or one or more portions thereof may alternatively be formed integrally with one or more other portions of the valve housing 102.

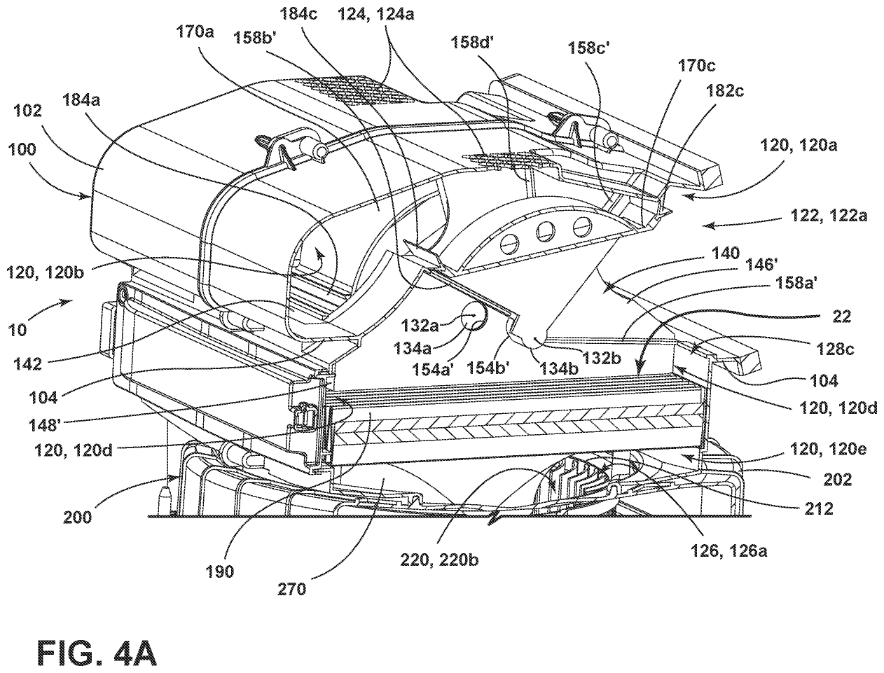

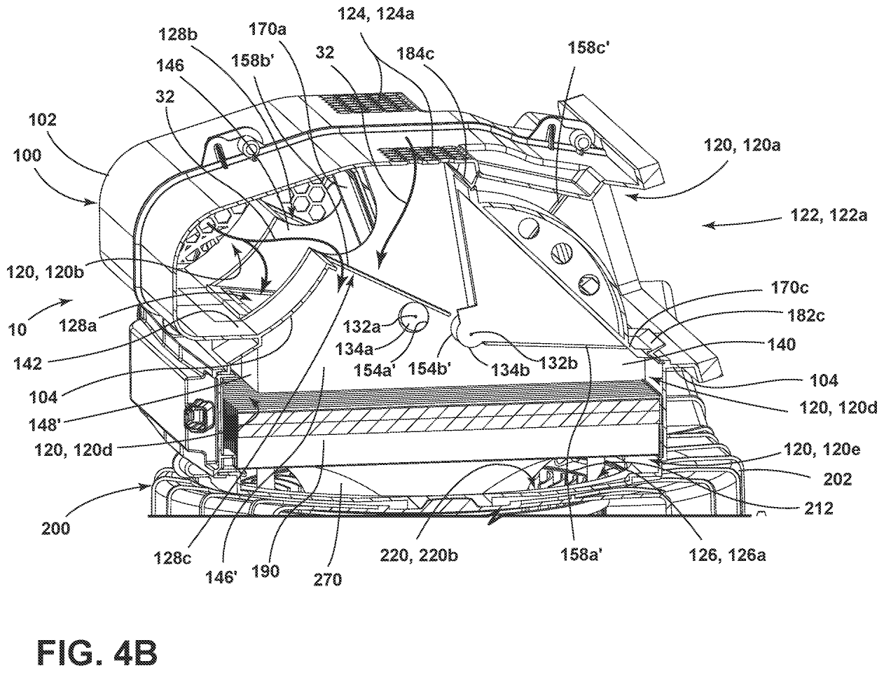

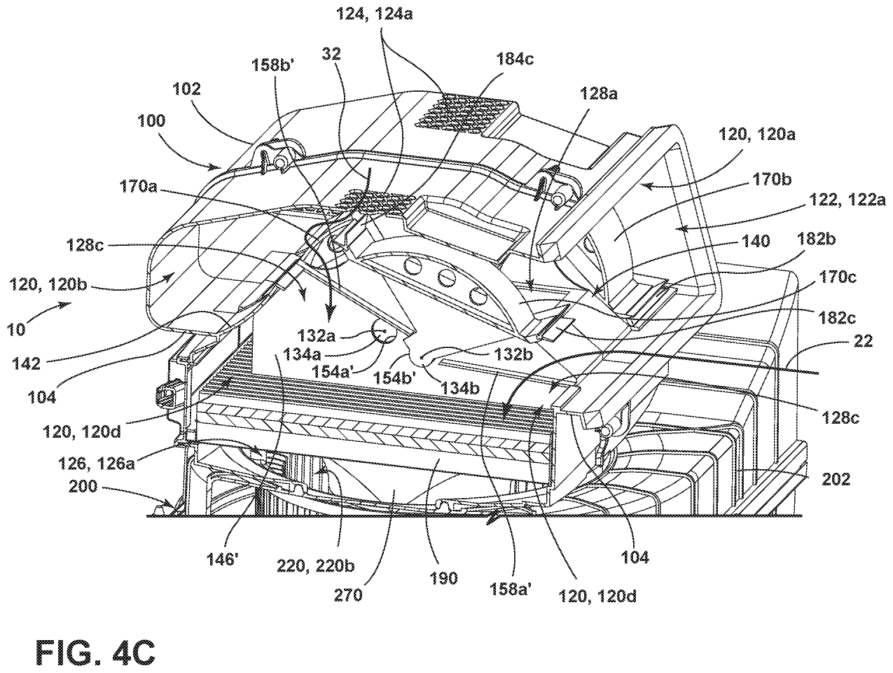

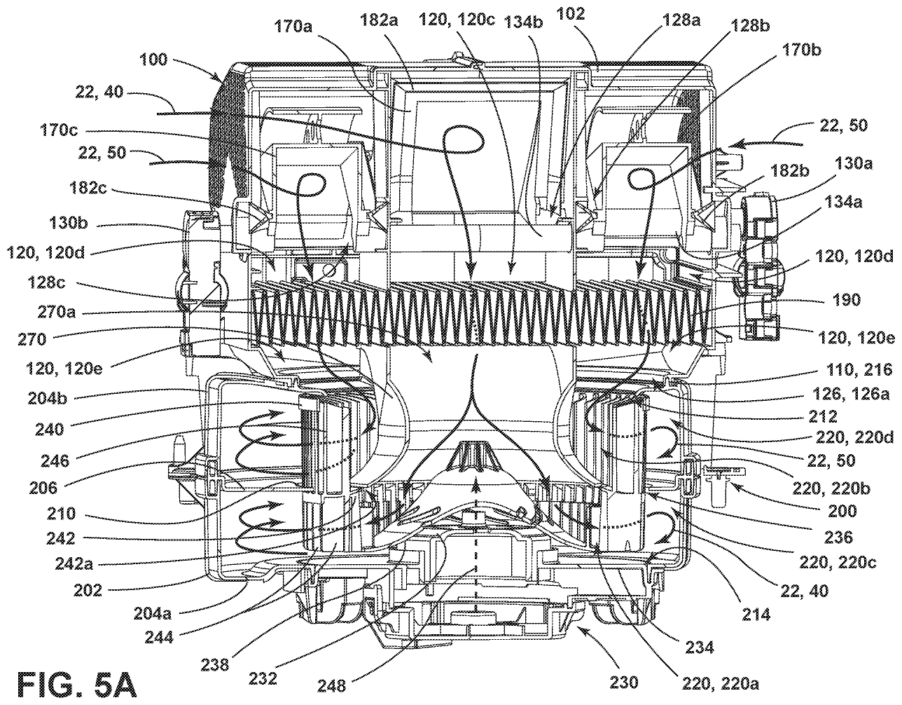

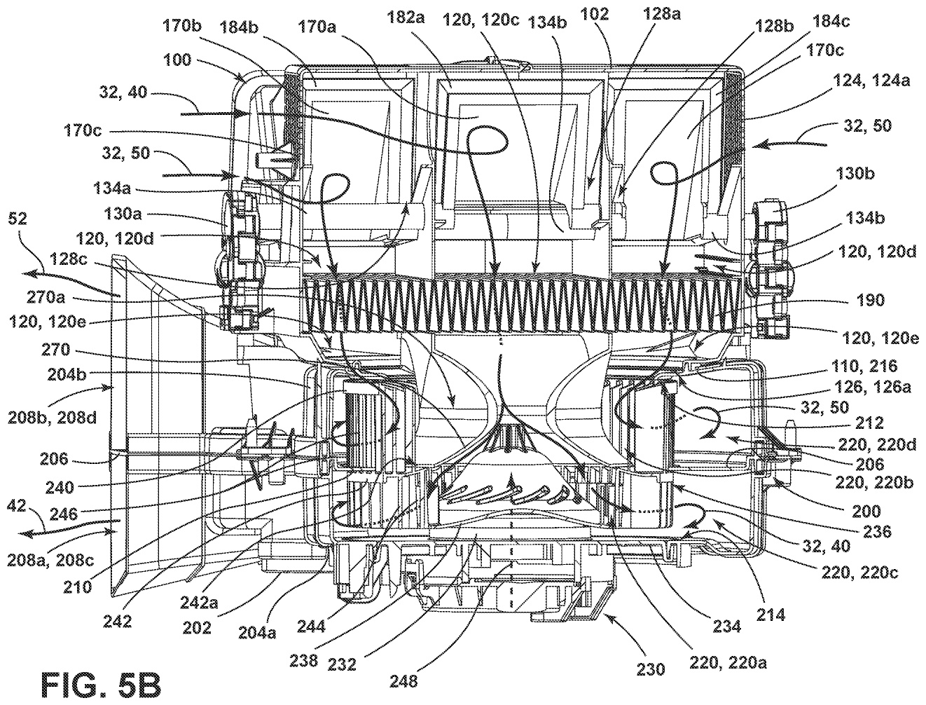

As generally illustrated in FIG. 2, the valve support 140 includes a base 142, an end wall 144, two support walls 146, 146′, and two connecting walls 148, 148′. The support walls 146, 146′ are disposed opposite one another and are connected to one another by the connecting walls 148, 148′, which are disposed opposite one another. The base 142 is connected to and extends transversely to the support walls 146, 146′ and the connecting walls 148, 148′. The base 142 is disposed offset from the partition 104 in a first/vertical direction (e.g., to account for and/or accommodate the offset arrangement of the axes 132a, 132b and shafts 134a, 134b) as generally shown in FIGS. 3A and 3B. The end wall 144 is connected to and extends between the support walls 146, 146′, and is disposed spaced apart from the base 142. The valve support 140 (e.g., the base 142 and/or support walls 146, 146′) includes and/or defines the first airflow opening 128a. The first unfiltered region 120c is disposed in the valve support 140 and is at least partially defined by the valve support 140 (e.g., the base 142 and walls 146, 146′, 148, 148′), which is shown in FIGS. 5A and 5B. As illustrated in FIGS. 3A-4C, the second unfiltered region 120d is disposed outside the valve support 140 and extends at least partially around the valve support 140. The end of the valve support 140 and/or the ends of the walls 146, 146′, 148, 148′ opposite the base 150 are disposed near, directly adjacent to, and/or in contact with the filter 190 such that valve support 140 and/or the walls 146, 146′, 148, 148′ at least partially separate and/or seal the first unfiltered region 120c and the second unfiltered region 120d from one another.

As generally illustrated in FIGS. 2-4C, the support walls 146, 146′ rotatably engage and/or contact the shafts 132a, 132b and support the shafts 132a, 132b and the valves 170a-170c within the valve housing 102. The support walls 146, 146′ each have a first shaft recess 154a, 154a′ for receiving the first shaft 134a and a second shaft recess 154b, 154b′ for receiving the second shaft 134b. Additionally, the support walls 146, 146′ each have a plurality of sealing projections 156a′ 156b′, 158a-158d, 158a′-158d′ the project from and extend longitudinal along the support wall 146, 146′. The sealing projections includes a first inner sealing projection 156a′ and a second inner sealing projection 156b′, which project toward the other support wall 146, 146′ and are selectively contacted by the first valve 170a to at least partially seal the first airflow opening 128a. The sealing projections includes a first, second, third, and fourth outer sealing projection 158a-158d, 158a′-158d′, which project away the other support wall 146, 146′ and are selectively contacted by an associated one of the second and third valves 170b, 170c to at least partially seal an associated one of the second and third airflow openings 128b, 128c. The valve support 140 (e.g., the first support wall 146 and/or the outer sealing projections 158a, 158b) at least partially defines the second airflow opening 128b. The valve support 140 (e.g., the second support wall 146′ and/or the outer sealing projections 158a′, 158b′) at least partially defines the third airflow opening 128c.

As generally illustrated in FIGS. 3A-4C, the valve housing 102 includes a plurality of airflow openings, including a first, second, and third airflow opening 128a, 128b, 128c. The first airflow opening 128a is disposed in and defined by the valve support 140. More specifically, the first airflow opening 128a is disposed in the base 142 and is at least partially defined by the base 142 and the support walls 146, 146′. The first airflow opening 128a fluidically connects each of the intake regions 120a, 120b to the first unfiltered region 120c. The first airflow opening 128a is selectively openable and closeable with respect to the intake regions 120a, 120b via the first valve 170a. The second airflow opening 128b is defined at least partially by the partition 104 and the valve support 140 (e.g., the first support wall 146 and/or the first and second outer sealing projections 158a, 158b). The third airflow opening 128c is defined at least partially by the partition 104 and the valve support 140 (e.g., the second support wall 146′ and/or the first and second outer sealing projections 158a′, 158b′). The second and third airflow openings 128b, 128c each fluidically connect each of the intake regions 120a, 120b to the second unfiltered region 120d. The second airflow opening 128b is selectively openable and closeable with respect to the intake regions 120a, 120b via the second valve 170b. The third airflow opening 128c is selectively openable and closeable with respect to the intake regions 120a, 120b via the third valve 170c.

As generally illustrated in FIGS. 1-5B, the valve assembly 100 includes a plurality of valves 170a-170c including a first, second, and third valve 170a, 170b, 170c. The valves 170a-170c are arranged in the valve housing 102 (e.g., in the VH internal space 120) between the first and second intake regions 120a, 120b and control the flow of air through the HVAC module 10. Each valve 170a-170c includes at least one seal 182a-182c, 184a-184c. The first seal 182a-182c is connected to and projects outward from the valve 170a-170c and extends at least partially around a first open end of the valve 170a-170c. The second seal 184a-184c is connected to and projects outward from valve 170a-170c and extends at least partially around a second open end of the valve 170a-170c. While the first seal 182a-182c and second seal 184a-184c are separate and independent elements in the illustrative example herein, the first seal 182a-182c and the second seal 184a-184c may conceivably be connected to one another and/or formed as a singular seal.

As generally illustrated in FIGS. 2-5B, the first valve 170a is disposed at least partially within the valve support 140, and is arranged between the second valve 170b and the third valve 170c relative to the first and second axes 132a, 132b. The first valve 170a is adjustable and/or rotatable about the first axis 132a to selectively open and close the first airflow opening 128a with respect to the intake regions 120a, 120b. The first valve 170a is connected to the first shaft 134a, which extends along and/or defines the first axis 132a. The first shaft 134a is disposed in and/or extends through (i) a first shaft recess 112 disposed in and defined by the first sidewall 108a of the valve housing 102, (ii) the first shaft recess 154a of the first support wall 146, and (iii) the first shaft recess 154a′ of the second support wall 146′ (see FIG. 2). The first shaft 134a extends only part way through the valve housing 102 (e.g., does not extend completely through the valve housing 102, nor contact or engage the second sidewall 108b of the valve housing 102). The first valve 170a and the first shaft 134a are supported by the valve support 140 and the valve housing 102. An end of the first shaft 134a is connected to the first actuator 130a (see FIGS. 1 and 5B). In other words, the first shaft 134a connects the first valve 170a and the first actuator 130a to one another. The first actuator 130a is disposed on a first side of the valve housing 102 and is arranged outside of the valve housing 102 adjacent to the first sidewall 108a of the valve housing 102. The first actuator 130a is configured to adjust the first valve 170a about the first axis 132a. The first actuator 130a is connected to the controller 12. The controller 12 is configured to control, operate, and/or actuate the first actuator 130a to rotate the first shaft 134a, which in turn adjusts and/or rotates the first valve 170a about the first axis 132a.

As generally illustrated in FIGS. 2-5B, the second valve 170b and the third valve 170c are arranged on opposite sides of the first valve 170a relative to the first and second axes 132a, 132b. The second valve 170b and the third valve 170c are adjustable and/or rotatable about the second axis 132b to selectively open and close the second airflow opening 128b and the third airflow opening 128c, respectively, with respect to the intake regions 120a, 120b. The second and third valves 170b, 170c are connected to the second shaft 134b, which extends along and/or defines the second axis 132b. The second shaft 134b is disposed in and/or extends through (i) a second shaft recess 114a disposed in and defined by the first sidewall 108a of the valve housing 102, (ii) a second shaft recess 114b disposed in and defined by the second sidewall 108b of the valve housing 102, (iii) the second shaft recess 154b of the first support wall 146, and (iv) the second shaft recess 154b′ of the second support wall 146′ (see FIG. 2). The second valve 170b, the third valve 170c, and the second shaft 134b are supported by the valve support 140 and the valve housing 102. The second shaft 134b extends completely through the valve housing 102. An end of the second shaft 134b is connected to the second actuator 130b (see FIG. 5A). In other words, the second shaft 134b connects the second and third valves 170b, 170c and the second actuator 130b to one another. The second actuator 130b is disposed on a second, opposite side of the valve housing 102 and is arranged outside of the valve housing 102 adjacent to the second sidewall 108b of the valve housing 102. The second actuator 130b is configured to adjust the second valve 170b and the third valve 170c about the second axis 132b. The second actuator 130b is connected to the controller 12. The controller 12 is configured to control, operate, and/or actuate the second actuator 130b to rotate the second shaft 134b, which in turn simultaneously adjusts and/or rotates the second valve 170b and the third valve 170c about the second axis 132b. As such, the controller 12 can control and/or actuate the second and third valves 170B, 170c independently of the first valve 170a, and vice versa.

As generally illustrated in FIGS. 3A-4C, the first axis 132a and/or first shaft 134a and the second axis 132b and/or the second shaft 134b are offset from one another in a first/vertical direction and a second/horizontal direction. The first/vertical direction generally extends from the first end wall 106a toward the second end wall 106b of the valve housing 102 (e.g., generally parallel to the blower axis 248). The second/horizontal direction generally extends from the first intake region 120a toward the second intake region 120b. The first/vertical direction and the second/horizontal direction are perpendicular to one another and are perpendicular to the first and second axes 132a, 132b. While the HVAC module 10 described herein includes two actuators 130a, 130b, the HVAC module 10 may include a single actuator that is connected to both shafts 134a, 134b and that controls, actuates, and/or rotates both shafts 134a, 134b independently of one another.

The first valve 170a is adjustable and/or rotatable about the first axis 132a to a variety of positions, including a first position (see FIGS. 3A, 4A, 4C, 5A), a second position (see FIGS. 1, 3B, 4B, 5B), and a plurality of intermediate positions between the first and second positions (e.g., an intermediate position similar to that of the third valve 170c shown in FIG. 4C). When in the first position (see FIGS. 3A, 4A, 4C, 5A), the second seal 184a contacts, abuts, and/or presses against the base 142 of the valve support 140 and the first seal 182a contacts, abuts, and/or presses against the first inner sealing projection 156a′ of each support wall 146, 146′ and a first end of the end wall 144 of the valve support 140. Thus, when in the first position, the first valve 170a closes the first airflow opening 128a with respect to the second intake region 120b and does not close the first airflow opening 128a with respect to the first intake region 120a such that the first input air 22 is permitted to flow through the first airflow opening 128a and the second input air 32 is restricted and/or prevented from flowing through the first airflow opening 128a. When in the second position (see FIGS. 1, 3B, 4B, 5B), the first seal 182a contacts, abuts, and/or presses against the base 142 of the valve support 140 and the second seal 184a contacts, abuts, and/or presses against the second inner sealing projection 156b′ of each support wall 146, 146′ and a second end of the end wall 144 of the valve support 140. Thus, when in the second position, the first valve 170a closes the first airflow opening 128a with respect to the first intake region 120a and does not close the first airflow opening 128a with respect to the second intake region 120b such that the second input air 32 is permitted to flow through the first airflow opening 128a and the first input air 22 is restricted and/or prevented from flowing through the first airflow opening 128a. When in one or more intermediate positions, the seals 182a, 184a do not contact the base 142, the inner sealing projections 156a′, 156b′, nor the end wall 144 of the valve support 140. Thus, when in one or more intermediate positions, the first valve 170a does not close the first airflow opening 128a with respect to the first intake region 120a nor the second intake region 120b such that both the first and second input air 22, 32 are permitted to flow through the first airflow opening 128a.

The second valve 170b is adjustable and/or rotatable about the second axis 132b to a variety of positions, including a first position (see FIGS. 3A, 4A, 5A), a second position (see FIGS. 1, 3B, 4B, 4C, 5B), and a plurality of intermediate positions between the first and second positions (e.g., an intermediate position similar to that of the third valve 170c shown in FIG. 4C). When in the first position (see FIGS. 3A, 4A, 5A), the first seal 182b contacts, abuts, and/or presses against the first end wall 106a of the valve housing 102 (e.g., a first protrusion thereof), the first sidewall 108a of the valve housing 102 (e.g., a protrusion thereof), and the third outer sealing projection 158c of the first support wall 146 and the second seal 184b contacts, abuts, and/or presses against the partition 104 and the second outer sealing projection 158b of the first support wall 146. Thus, when in the first position, the second valve 170b closes the second airflow opening 128b with respect to the second intake region 120b and does not close the second airflow opening 128b with respect to the first intake region 120a such that the first input air 22 is permitted to flow through the second airflow opening 128b and the second input air 32 is restricted and/or prevented from flowing through the second airflow opening 128b. When in the second position (see FIGS. 1, 3B, 4B, 4C, 5B), the first seal 182b contacts, abuts, and/or presses against the partition 104 and the first outer sealing projection 158a of the first support wall 146 and the second seal 184b contacts, abuts, and/or presses against the first end wall 106a of the valve housing 102 (e.g., a first protrusion thereof), the first sidewall 108a of the valve housing 102 (e.g., a protrusion thereof), and the fourth outer sealing projection 158d of the first support wall 146. Thus, when in the second position, the second valve 170b closes the second airflow opening 128b with respect to the first intake region 120a and does not close the second airflow opening 128b with respect to the second intake region 120b such that the second input air 32 is permitted to flow through the second airflow opening 128b and the first input air 22 is restricted and/or prevented from flowing through the second airflow opening 128b. When in one or more intermediate positions, the seals 182b, 184b do not contact the partition 104, the outer sealing projections 158a-158d of the first support wall 146, the first sidewall 108a of the valve housing 102, nor the first end wall 106a of the valve housing 102. Thus, when in one or more intermediate positions, the second valve 170b does not close the second airflow opening 128b with respect to the first intake region 120a nor the second intake region 120b such that both the first and second input air 22, 32 are permitted to flow through the second airflow opening 128b.

The third valve 170c is adjustable and/or rotatable about the second axis 132b to a variety of positions, including a first position (see FIGS. 3A, 4A, 5A), a second position (see FIGS. 1, 3B, 4B, 5B), and a plurality of intermediate positions between the first and second positions (see FIG. 4C). When in the first position (see FIGS. 3A, 4A, 5A), the first seal 182c contacts, abuts, and/or presses against the first end wall 106a of the valve housing 102 (e.g., a second protrusion thereof), the second sidewall 108b of the valve housing 102 (e.g., a protrusion thereof), and the third outer sealing projection 158c′ of the second support wall 146′ and the second seal 184c contacts, abuts, and/or presses against the partition 104 and the second outer sealing projection 158b′ of the second support wall 146′. Thus, when in the first position, the third valve 170c closes the third airflow opening 128c with respect to the second intake region 120b and does not close the third airflow opening 128c with respect to the first intake region 120a such that the first input air 22 is permitted to flow through the third airflow opening 128c and the second input air 32 is restricted and/or prevented from flowing through the third airflow opening 128c. When in the second position (see FIGS. 1, 3B, 4B, 5B), the first seal 182c contacts, abuts, and/or presses against the partition 104 and the first outer sealing projection 158a′ of the second support wall 146′ and the second seal 184c contacts, abuts, and/or presses against the first end wall 106a of the valve housing 102 (e.g., a second protrusion thereof), the second sidewall 108b of the valve housing 102 (e.g., a protrusion thereof), and the fourth outer sealing projection 158d′ of the second support wall 146′. Thus, when in the second position, the third valve 170c closes the third airflow opening 128c with respect to the first intake region 120a and does not close the third airflow opening 128c with respect to the second intake region 120b such that the second input air 32 is permitted to flow through the third airflow opening 128c and the first input air 22 is restricted and/or prevented from flowing through the third airflow opening 128c. When in one or more intermediate positions (see FIG. 4C), the seals 182c, 184c do not contact the partition 104, the outer sealing projections 158a′-158d′ of the second support wall 146′, the second sidewall 108b of the valve housing 102, nor the first end wall 106a of the valve housing 102. Thus, when in one or more intermediate positions, the third valve 170c does not close the third airflow opening 128c with respect to the first intake region 120a nor the second intake region 120b such that both the first and second input air 22, 32 are permitted to flow through the third airflow opening 128c.

As generally illustrated in FIGS. 2-5B, the filter 190 is configured to remove and/or collect impurities from air (e.g., the input air 22, 33, the first airflow 40, and/or the second airflow 50) flowing through the filter 190. The filter 190 is arranged in the valve housing 102 (e.g., the VH internal space 120). The filter 190 is releasably engaged by and/or connected to the valve housing 102 (e.g., one or more sidewalls thereof) enabling the filter 190 to be easily removed and replaced, such as by removing an access panel and/or cover that closes an opening in valve housing 102. The inlets 122, 124, the first end wall 106a of the valve housing 102, the partition 104, the valve support 140, the airflow openings 170a-170c, and the unfiltered regions 120c, 120d are disposed on a first side of the filter 190 and the second end wall 106b of the valve housing 102, the air outlet 126, the air funnel 270, and the filtered region 120e are disposed on a second, opposite side of the filter 190, at least with respect to a throughflow direction of the HVAC module 10. The filter 190 is disposed between and/or separates (to at least an extent) the first unfiltered region 120c and the funnel inner space 270a such that the first airflow 40 is flowable (e.g., exclusively) from the first unfiltered region 120c into the funnel inner space 270a via flowing through the filter 190. The filter 190 is also disposed between and/or separates (to at least an extent) the second unfiltered region 120d and the filtered region 120e such that the second airflow 50 is flowable (e.g., exclusively) from the second unfiltered region 120d into the filtered region 120e via flowing through the filter 190.

As generally illustrated in FIGS. 3A-5B, the VH internal space 120 includes a first intake region 120a, a second intake region 120b, a first unfiltered region 120c, a second unfiltered region 120d, and a filtered region 120e.

As generally illustrated in FIGS. 3A-4C, the first intake region 120a is defined at least partially by a first section and/or region of the valve housing 102 (e.g., a first portion of the first end wall 106a, a first portion of the partition 104, and a first portion of one or more sidewalls 108a-108c disposed on a first side of the valves 170a-170c and/or the valve support 140). The second intake region 120b is defined at least partially by a second section and/or region of the valve housing 102 (e.g., a second portion of the first end wall 106a, a second portion of the partition 104, and a second portion of one or more sidewalls disposed 108a, 108b, 108d on a second, opposite side of the valves 170a-170c and/or the valve support 140). In other words, the first intake region 120a and the second intake region 120b are disposed on opposite sides of the valves 170a-170c and/or the valve support 140.

The intake regions 120a, 120b are in selective fluid communication with one another and may be selectively closed off and/or sealed from one another via the valves 170a-170c. For example, the intake regions 120a, 120b are in fluid communication when one another when one or more of the valves 170a-170c is disposed in an intermediate position. The intake regions 120a, 120b are fluidically sealed off from one another via the valves 170a-170c when the valves 170a-170c are each disposed in one of the first and second positions (e.g., the valves 170a-170c are each in the first position; the first valve 170a is in the first position and the second and third valves 170b, 170c are in the second position; etc.). The first intake region 120a and the second intake region 120b are in selective fluid communication with the unfiltered regions 120c, 120d via the valve openings 128a-128c and may be selectively closed off and/or sealed from one or more of the unfiltered regions 120c, 120d via the valves 170a-170c.

As generally illustrated in FIGS. 5A and 5B, the first unfiltered region 120c is disposed in the valve support 140. The first unfiltered region 120c is at least partially defined by the valve support 140 (e.g., the base 142 and walls 146, 146′, 148, 148′) and the filter 190. The first unfiltered region 120c is in fluid communication with the funnel inner space 270a via the filter 190. The first unfiltered region 120c is in selective fluid communication with the intake regions 120a, 120b via the first airflow opening 128a and may be selectively closed off and/or sealed from one or more of the intake regions 120a, 120b via the first valve 170a. The first unfiltered region 120c and the first intake region 120a are (i) in fluid communication when the first valve 170a is the first position or in an intermediate position and (ii) not in fluid communication when the first valve 170a is in the second position. The first unfiltered region 120c and the second intake region 120b are (i) in fluid communication when the first valve 170a is the second position or in an intermediate position and (ii) not in fluid communication when the first valve 170a is in the first position.

As generally illustrated in FIGS. 3A-5B, the second unfiltered region 120d is defined at least partially by the valve housing 102 (e.g., the partition 104 and one or more of the sidewalls 108a-108d), the valve support 140 (e.g., the walls 146, 146′, 148, 148′ and the outer sealing projections 158a, 158b, 158a′, 158b′), and the filter 190. The second unfiltered region 120d is disposed outside the valve support 140 and extends at least partially around the valve support 140 (e.g., circumferentially). The second unfiltered region 120d is in fluid communication with the filtered region 120e via the filter 190. The second unfiltered region 120d is in selective fluid communication with the intake regions 120a, 120b via the second and third airflow openings 128b, 128c, and may be selectively closed off and/or sealed from one or more of the intake regions 120a, 120b via the second and third valves 170b, 170c. The second unfiltered region 120d and the first intake region 120a are (i) in fluid communication when the second and third valves 170b, 170c are in the first position or in one or more intermediate positions and (ii) not in fluid communication when the second and third valves 170b, 170c are in the second position. The second unfiltered region 120d and the second intake region 120b are (i) in fluid communication when the second and third valves 170b, 170c are in the second position or in one or more intermediate positions and (ii) not in fluid communication when the second and third valves 170b, 170c are in the first position.

As generally illustrated in FIGS. 3A-5B, the filtered region 120e is defined at least partially by the filter 190, the valve housing 102 (e.g., the second end wall 106b and one or more of the sidewalls 108a-108d), and the air funnel 270. The filtered region 120e is disposed outside of and extends at least partially around the air funnel 270 (e.g., circumferentially). The filtered region 120e is in fluid communication with the second unfiltered region 120d via the filter 190. The filtered region 120e is in fluid communication with the blower assembly 200 (e.g., the second inner region 220b) via the air outlet 126 and the inflow opening 212.

As generally illustrated in FIGS. 1, 2, 5A, and 5B, the blower housing 202 includes two housing shells 204a, 204b, a separation panel 206 connected to the housing shells 204a, 204b, and a plurality of outlets (e.g., a first outlet 208a and a second outlet 208b). The housing shells 204a, 204b are attached and/or connected to one another and define an internal space 220 (i.e., BH internal space 220) in which the blower 230 and the air funnel 270 are at least partially arranged. The separation panel 206 is arranged and/or sandwiched between the housing shells 204a, 204b and is disposed at least partially in the BH internal space 220. The separation panel 206 includes and/or defines a panel aperture 210 that receives at least a portion of the blower 230 (e.g., the blower wheel 236) and/or at least a portion of the air funnel 270.

As generally illustrated in FIG. 1, the blower housing 202 may be considered to include and/or be divided into two sections (e.g., a first housing section 202a and a second housing section 202b) at or about the separation panel 206. The first housing section 202a is the lower portion and/or ‘half’ of the blower housing 202 defined by and/or including the first housing shell 204a, the separation panel 206, and the first outlet 208a. The second housing section 202b is the upper portion and/or ‘half’ of the blower housing 202 defined by and/or including the second housing shell 204b, the separation panel 206, and the second outlet 208b.

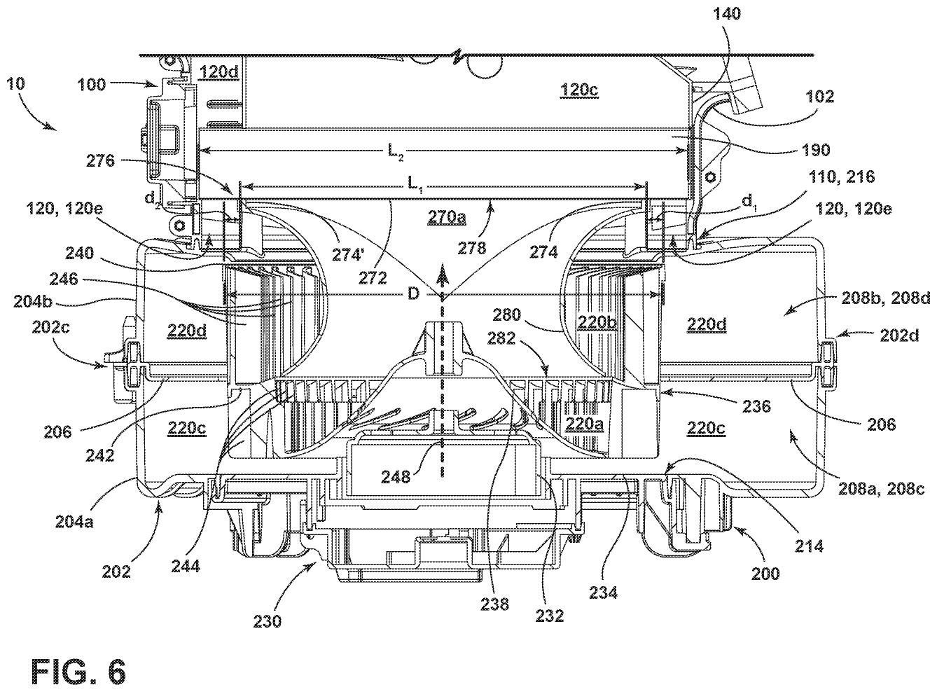

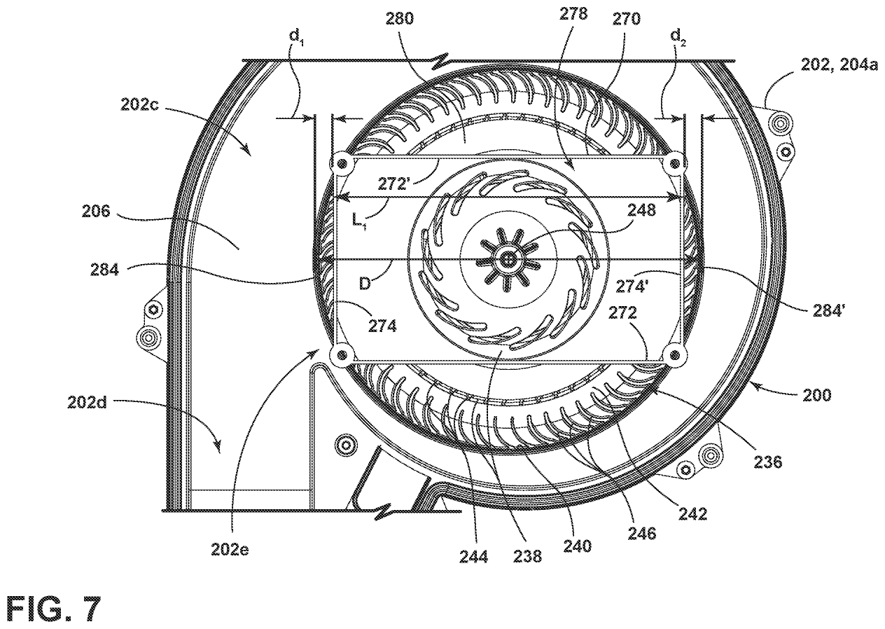

As generally illustrated in FIGS. 6 and 7, the blower housing 202 includes a main and/or scroll portion 202c and a branch portion 202d. The scroll portion 202c is generally cylindrical in shape and at least partially houses the blower 230 (e.g., the blower wheel 236) and the air funnel 270. The branch portion 202d is connected to and tangentially extends, projects, splits, and/or diverges from the scroll portion 202c at or about a scroll exit region 202e. The branch portion 202d includes the outlets 208a, 208b. The scroll portion 202c and the branch portion 202d each partially define a section and/or portion of the first and second flow regions 220c, 220d of the BH internal space 220.

As generally illustrated in FIGS. 1, 2, and 5B, the blower housing 202 includes a plurality of outlets 208a, 208b via which air (i.e., input air 22, 32 received from the valve assembly 100 as the first airflow 40 and/or the second airflow 50) is output, expelled, and/or flowable out of the blower assembly 200 and/or the HVAC module 10. The first outlet 208a outputs and/or expels the first airflow 40 as first output air 42, which may ultimately be directed to one or more first destinations (e.g., one or more first/defrost zones of a vehicle internal space and/or cabin, one or more upper portions or regions of a vehicle internal space and/or cabin, and/or a windshield of a vehicle). The first outlet 208a includes and/or is defined by a first outlet opening 208c, which is defined and/or formed by the first housing shell 204a and the separation panel 206. The second outlet 208b outputs and/or expels the second airflow 50 as second output air 52, which may ultimately be directed to one or more second destinations (e.g., one or more second/lower/footwell zones of a vehicle internal space and/or cabin, lower portions or regions of a vehicle internal space and/or cabin, and/or footwells of the vehicle). The second outlet 208b includes and/or is defined by a second outlet opening 208d, which is defined and/or formed by the second housing shell 204b and the separation panel 206.

As generally illustrated in FIGS. 2-5B, the second housing shell 204b includes and/or defines the inflow opening 212 via which air (i.e., input air 22, 32 received from the valve assembly 100 as the first airflow 40 and/or the second airflow 50) is flowable into the blower assembly 200 from the valve assembly 100. The second inner region 220b and the filtered region 120e are in direct fluid communication with one another via the inflow opening 212. The air funnel 270 is disposed partially in the inflow opening 212 and projects from the blower housing 202 (e.g., the BH internal space 220) via the inflow opening 212. As such, the air outlet 126 and the inflow opening 212 enable fluid communication between the first unfiltered region 120c and the first inner region 220a via the air funnel 270.

As generally illustrated in FIGS. 3A, 5A, and 5B, the second housing shell 204b further includes an attachment formation 216 configured to engage the complimentary attachment formation 110 of the valve housing 102 and at least partially attach and/or seal the valve assembly 100 (e.g., the valve housing 102) and the blower assembly 200 (e.g., the blower housing 202). The attachment formation 216 includes a projection that engages and/or is received in the complimentary channel of the attachment formation 110 of the valve housing 102. The projection of the attachment formation 216 extends around and/or encircles the inflow opening 212.

As generally illustrated in FIGS. 5A and 5B, the first housing shell 204a includes a shell aperture 214 that receives and (e.g., releasably) retains at least a portion of the blower 230 (e.g., the blower motor 232, motor housing 234). The shell aperture 214 facilitates insertion and/or arrangement of at least a portion the blower 230 (e.g., the blower wheel 236) within the blower housing 202 and/or the BH internal space 220. The shell aperture 214 is closed and/or sealed by one or more portions of the blower 230 (e.g., the motor housing 234).

As generally illustrated in FIGS. 5A-6, the blower 230 is at least partially arranged in the blower housing 202 and/or the BH internal space 220. The blower 230 is partially disposed in and projects through the shell aperture 214 into the BH internal space 220. The blower 230 includes a blower motor 232, a motor housing 234, and a blower wheel 236. The blower motor 232 is disposed and/or mounted in the motor housing 234. The motor housing 234 is (e.g., releasably) connected to the blower housing 202 and closes and/or seals the shell aperture 214. The blower motor 232 and/or the motor housing 234 are disposed at least partially in and/or extend through the shell aperture 214. The blower motor 232 is connected to the blower wheel 236 (e.g., via a drive shaft). The blower motor 232 is configured to rotate and/or spin the blower wheel 236 about a blower axis 248. The blower 230 and/or the blower motor 232 is connected to the controller 12. The controller 12 is configured to control, operate, and/or actuate the blower motor 232 to rotate and/or spin the blower wheel 236, which in turn generates flow through the HVAC module 10, the valve assembly 100, and/or the blower assembly 200 (e.g., draws air 22, 32 through the inlets 122, 124 into the valve assembly 100 and through the valve assembly 100 into the blower assembly 200, and/or drives and/or pushes air through the blower assembly 200 and out the outlets 208a, 208b).

As generally illustrated in FIGS. 5A-7, the blower wheel 236 includes a hub 238, an annular perimeter wall 240, an annular intermediate wall 242, a plurality of first blades 244, and a plurality of second blades 246. The hub 238 is disposed at or about a first axial end of the blower wheel 236 and is connected to the blower motor 232 (e.g., via a drive shaft). The hub 238 generally extends and/or lies transversely to the blower axis 248. The perimeter wall 240 extends around an outer circumference and/or perimeter of the blower wheel 236 at a second axial end of the blower wheel 236 opposite the hub 238. The intermediate wall 242 generally extends and/or lies transversely to the blower axis 248 and is disposed axially between the perimeter wall 240 and at least a portion of the hub 238 (e.g., the portion connected to the first blades 244). The first blades 244 extend axially between and connect the hub 238 and the intermediate wall 242, and are disposed circumferentially spaced apart from one another around a radially outer perimeter of the blower wheel 236. The second blades 246 extend axially between and connect the perimeter wall 240 and the intermediate wall 242, and are disposed circumferentially spaced apart from one another around the radially outer perimeter of the blower wheel 236.

As generally illustrated in FIGS. 5A-6, the intermediate wall 242 is curved and directs and/or guides the second airflow 50 in the second inner region 220b radially outward, where the second airflow 50 passes between the second blades 246 and into the second flow region 220d. The intermediate wall 242 includes and/or defines a through opening 242a that is disposed at least partially axially aligned with the blower axis 248, a portion of the hub 238 (i.e., the bell-shaped dome), and the air funnel 270. An end of the air funnel 270 (e.g., a second end) is disposed near, directly adjacent to, and/or in close proximity to an edge of the intermediate wall 242 defining the through opening 242a such that the first airflow 40 flows from the funnel inner space 270a into the first inner region 220a via the through opening 242a. A central region and/or portion of the hub 238 is structured as a bell-shaped dome that, optionally, projects at least partially into the funnel inner space 270a. The bell-shaped dome directs and/or guides the first airflow 40 in the first inner region 220a radially outward, where the first airflow 40 passes between the first blades 244 and into the first flow region 220c.

The blower wheel 236 may be considered to include and/or be divided into two sections (e.g., a first wheel section and a second wheel section) at or about the intermediate wall 242. The first wheel section is the lower portion and/or ‘half’ of the blower wheel 236 defined by and/or including the hub 238, the intermediate wall 242, and the first blades 244. The second wheel section is the upper portion and/or ‘half’ of the blower wheel 236 defined by and/or including the perimeter wall 240, the intermediate wall 242, and the second blades 246.

As generally illustrated in FIGS. 2-5B, the blower assembly 200 includes an air funnel 270 via which the first airflow 40 enters and/or flows into the blower housing 202. The air funnel 270 defines an inner space 270a (also referred to as the ‘funnel inner space’). The air funnel 270 is disposed partially in the valve housing 102 (e.g., the VH internal space 120), the air outlet 126, the blower housing 202 (e.g., the BH internal space 220), and the inflow opening 212. The air funnel 270 projects from the blower housing 202 via the inflow opening 212 and extends into the valve housing 102 via the air outlet 126. A first axial end of air funnel 270 is connected to the second housing shell 204b and is disposed within the valve housing 102 (e.g., the VH internal space 120) near, directly adjacent to, and/or in contact with the filter 190. A second axial end of the air funnel 270 is disposed in the blower housing 202 (e.g., the BH internal space 220) and the blower wheel 236, near, directly adjacent to, and/or in the through opening 242a and/or the intermediate wall 242 of the blower wheel 236.

As generally illustrated in FIG. 7, the air funnel 270 includes two major sidewalls 272, 272′and two minor sidewalls 274, 274′. The two minor sidewalls 274, 274′ extend between and connect the two major sidewalls 272, 272′ to define and/or form a rectangle in which the minor sidewalls 274, 274′ define and/or form the minor/short sides of the rectangle and the major sidewalls 272, 272′ define and/or form the major/long sides of the rectangle. The sidewalls 272, 272′, 274, 274′ of the air funnel 270 are part of and/or at least partially define a rectangular base portion 276 of the air funnel 270, which is connected to the second housing shell 204b. The sidewalls 272, 272′, 274, 274′ and/or the base portion 276 are disposed at the first axial end of the air funnel 270 and define a funnel inflow opening 278 via which the first airflow 40 enters and/or flows into the air funnel 270 and/or the funnel inner space 270a.

As generally illustrated in FIG. 6, the air funnel 270 further includes a circumferential wall 280 that is connected to and projects axially from the base portion 276. The circumferential wall 280 is configured and/or structured in the manner of and/or similar to a hyperboloid and, thus, may be referred to as a hyperboloid wall 280. The circumferential wall 280 is disposed at least partially at the second axial end of the air funnel 270 and defines a funnel outflow opening 282 via which the first airflow 40 exits and/or flows out of the air funnel 270 (e.g., into the first inner region 220a).

As generally illustrated in FIGS. 6 and 7, a dimension/length L₁ of the rectangular base portion 276 extending in the second/horizontal direction (i.e., transversely and/or perpendicular to the axes 132a, 132b and to the blower axis 248) is less and/or smaller than a dimension/length L₂ of the filter 190. The length L₁ of the base portion 276 is defined by and between the external surfaces of the two minor sidewalls 274, 274′ of the base portion 276. The two minor sidewalls 274, 274′ extend substantially parallel to the axes 132a, 132b, the shafts 134a, 134b, and/or the branch portion 202d. In addition, the first minor sidewall 274 (e.g., a first side of the base portion 276) is disposed near and/or adjacent to where the branch portion 202d of the blower housing 202 extends and/or splits off from the scroll portion 202c (i.e., the scroll exit region 202e).

As generally illustrated in FIG. 7, a longitudinal length of the first minor sidewall 274 (e.g., in a third direction parallel to the axes 132a, 132b) is equal to or greater than a first chord of the blower wheel 236 that is parallel to and disposed in alignment with the first minor sidewall 274 in the first/vertical direction such that, when viewed in the first/vertical direction, the first minor sidewall 274 intersects the outer perimeter of the blower wheel 236 at two points and a circle segment shaped first flow area 284 is defined by and between the first minor sidewall 274 and the outer perimeter of the blower wheel 236. The external surface of the first minor sidewall 274 (i.e., a first side of the base portion 276) is disposed a first distance d₁ in the second/horizontal direction from the outer perimeter of the blower wheel 236 (e.g., from a vertex of the arc of the circle segment shape of the first flow area 284). In other words, a maximum dimension of the first flow area 284 in the second/horizontal direction is equal to the first distance d₁.

As generally illustrated in FIG. 7, a longitudinal length of the second minor sidewall 274′ (e.g., in the third direction parallel to the axes 132a, 132b) is equal to or greater than a second chord of the blower wheel 236 that is parallel to and disposed in alignment with the second minor sidewall 274′ in the first/vertical direction such that, when viewed in the first/vertical direction, the second minor sidewall 274′ intersects the outer perimeter of the blower wheel 236 at two points and a circle segment shaped second flow area 284′ is defined by and between the second minor sidewall 274′ and the outer perimeter of the blower wheel 236. The external surface of the second minor sidewall 274′ (i.e., a second side of the base portion 276) is disposed a second distance d₂ in the second/horizontal direction from the outer perimeter of the blower wheel 236 (e.g., from a vertex of the arc of the circle segment shape, or arc vertex, of the second flow area 284′). In other words, a maximum dimension of the second flow area 284′ in the second/horizontal direction is equal to the second distance d₂.

As generally illustrated in FIG. 7, a first distance-diameter ratio R_{d1} of the first distance d₁ to the diameter D of the blower wheel 236 is 0.05 to 0.15 (i.e., R_{d1}=d₁/D=0.05 to 0.15), preferably 0.10. The diameter D of the blower wheel 236 is measured at and/or defined by the outer perimeter of the second blades 246 (e.g., at its widest point). For example, the diameter of the blower wheel may be A second distance-diameter ratio R_{d2} of the second distance d₂ to the diameter D of the blower wheel 236 is 0.05 to 0.15 (i.e., R_{d2}=d₂/D=0.05 to 0.15), preferably 0.10. An area ratio R_{A} of the total combined flow area A_{Total} of the flow areas 284, 284′ to the area A_{Blower} of the blower wheel 236 is 0.05 to 0.25 (i.e., R_{A}=A_{Total}/A_{Blower}=0.05 to 0.25), preferably 0.05 to 0.15. The blower area A_{Blower} can be calculated using the formula

$${A}_{Blower} = π \times {( \frac{D}{2} )}^{2} ,$$

where D is the diameter of the blower wheel 236. The total combined flow area A_{Total} of the flow areas 284, 284′ can be calculated by adding/summing the area A_{FA1} of the first flow area 284 and the area A_{FA2} of the second flow area 284′ (i.e., A_{Total}=A_{FA1}+A_{FA2}). The area A_{FA1} of the first flow area 284 can be calculated using the formula

$${A}_{FA 1} = ( \frac{{θ}_{1} \times π}{360} - \frac{sin {θ}_{1}}{2} ) \times {( \frac{D}{2} )}^{2} ,$$

where D is the diameter of the blower wheel 236 and θ₁ is the first segment angle in degrees. The first segment angle θ₁ is defined between a first imaginary radial line extending from the blower axis 248 (i.e., the center of the blower wheel 236) to a first end of the first chord and a second imaginary radial line extending from the blower axis 248 to a second, opposite end of the first chord. The area A_{FA2} of the second flow area 284′ can be calculated using the formula

$${A}_{FA 2} = ( \frac{{θ}_{2} \times π}{360} - \frac{sin {θ}_{2}}{2} ) \times {( \frac{D}{2} )}^{2} ,$$

where D is the diameter of the blower wheel 236 and θ₂ is the second segment angle in degrees. The second segment angle θ₂ is defined between a first imaginary radial line extending from the blower axis 248 to a first end of the second chord and a second imaginary radial line extending from the blower axis 248 to a second, opposite end of the second chord. The first flow area 284, the area A_{FA1} of the first flow area 284, the second flow area 284′, the area A_{FA2} of the second flow area 284′, and blower area A_{Blower} each lie in a plane perpendicular to the first/vertical direction and/or the blower axis 248.

Surprisingly, Applicant has found that providing the rectangular base portion 276 of the air funnel 270 with a length L₁ that is smaller than the length L₂ of the filter 190 did not compromise the sealing and/or separation of the first airflow 40 and the second airflow 50 after passing though the filter 190 (i.e., separation of the first airflow 40 in the air funnel 270 and the second airflow 50 in the filtered region 120e). Applicant also surprisingly found that the difference between L₁ and L₂, as well as the size/area of the first and second flow areas 284, 284′ relative to one another and to the diameter D of the blower wheel 236, influenced airflow in the scroll exit region 202e of the blower housing 202. Moreover, Applicant was able to achieve reduced airflow restriction and/or improved airflow in the scroll exit region 202e by providing the rectangular base portion of the air funnel 270 with a length L₁ that is smaller than the length L₂ of the filter 190 and utilizing a first distance-diameter ratio R_{d1}, a second distance-diameter ratio R_{d2}, and an area ratio R_{A} that were each within the above described ranges. This, in turn, improved efficiency of the blower 230 and/or the HVAC module 10 and eliminated or at least reduced the amount of noise generated during operation of the blower 230 and/or the HVAC module 10.

As generally illustrated in FIGS. 5A-6, the BH internal space 220 includes a first inner region 220a, a second inner region 220b, a first flow region 220c, and a second flow region 220d.

The first inner region 220a is at least partially disposed in and/or defined by the first wheel section of the blower wheel 236. More specifically, the first inner region 220a is at least partially defined by the hub 238, the intermediate wall 242, the first blades 244, and the second end of the air funnel 270. The first airflow 40 enters and/or flows into the first inner region 220a via the air funnel 270. The first airflow 40 exits and/or flows out of the first inner region 220a and into the first flow region 220c by passing between the first blades 244 (e.g., via flowing through the gaps and/or openings defined between the first blades 244).

The second inner region 220b is at least partially disposed in and/or defined by the second wheel section of the blower wheel 236. More specifically, the second inner region 220b is at least partially defined by the first housing shell 204a, the inflow opening 212, the perimeter wall 240, the intermediate wall 242, the second blades 246, and/or the air funnel 270 (e.g., the circumferential wall 280). The second airflow 50 enters and/or flows into the second inner region 220b from the filtered region 120e by way of the air outlet 126 and the inflow opening 212. The second airflow 50 exits and/or flows out of the second inner region 220b and into the second flow region 220d by passing between the second blades 246 (e.g., via flowing through the gaps and/or openings defined between the second blades 246). The first inner region 220a and the second inner region 220b are substantially separated from one another by the intermediate wall 242 of the blower wheel 236 and/or the air funnel 270.

The first flow region 220c is at least partially disposed in and/or defined by the first housing section 202a of the blower housing 202. More specifically, the first flow region 220c is at least partially defined by the first housing shell 204a, the separation panel 206, and the blower wheel 236 (e.g., the first wheel section). The first inner region 220a, the funnel inner space 270a, and the VH internal space 120 (e.g., the first unfiltered region 120c) are in fluid communication with the first outlet 208a via the first flow region 220c.

The second flow region 220d is at least partially disposed in and/or defined by the second housing section 202b of the blower housing 202. More specifically, the second flow region 220d is at least partially defined by the second housing shell 204b, the separation panel 206, and the blower wheel 236 (e.g., the second wheel section). The second inner region 220b and the VH internal space 120 (e.g., the second unfiltered region 120d and the filtered region 120e) are in fluid communication with the second outlet 208b via the second flow region 220d. The first flow region 220c and the second flow region 220d are disposed on opposite sides of the separation panel 206 and substantially separated from one another by the separation panel 206.

As generally illustrated in FIG. 1, the controller 12 includes an electronic controller and/or includes an electronic processor, such as a programmable microprocessor and/or microcontroller. The controller 12 may also include an application specific integrated circuit (ASIC), a central processing unit (CPU), a memory (e.g., a non-transitory computer-readable storage medium), and/or an input/output (I/O) interface. The controller 12 is configured to perform various functions, including those described in greater detail herein, with appropriate programming instructions and/or code embodied in software, hardware, and/or other medium. The controller 12 is, optionally, connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A blower assembly for a heating, ventilation, and air conditioning (HVAC) module, comprising:
a blower including a blower wheel; and
an air funnel including a base portion and a circumferential wall connected to and projecting from the base portion;
wherein, when viewed in a first direction parallel to a blower axis, a first flow area is defined by and between a first side of the base portion and an outer perimeter of the blower wheel and a second flow area is defined by and between a second side of the base portion and the outer perimeter of the blower wheel.

2. The blower assembly of claim 1, wherein:
the blower wheel has a diameter;
when viewed in the first direction, the first side of the base portion is disposed a distance from the outer perimeter of the blower wheel in a second direction that is perpendicular to the first direction and to the first side of the base portion; and
a ratio of the distance to the diameter is 0.05 to 0.15.

3. The blower assembly of claim 2, wherein the ratio of the distance to the diameter is 0.10.

4. The blower assembly of claim 2, wherein a maximum dimension of the first flow area in the second direction is equal to the distance.

5. The blower assembly of claim 2, wherein:
the first flow area is circle segment shaped; and
the distance extends from the first side of the base portion to an arc vertex of the first flow area.

6. The blower assembly of claim 1, wherein the first flow area and the second flow area are each circle segment shaped.

7. The blower assembly of claim 1, wherein a ratio of a total combined flow area of the first flow area and the second flow area to a blower area of the blower wheel is 0.05 to 0.25.

8. The blower assembly of claim 7, wherein the ratio of the total combined flow area of the first flow area and the second flow area to the blower area is 0.05 to 0.15.

9. The blower assembly of claim 7, wherein the first flow area, the second flow area, and the blower area each lie in a plane perpendicular to the blower axis.

10. The blower assembly of claim 1, wherein the base portion of the air funnel is rectangular.

11. The blower assembly of claim 10, wherein:
the air funnel includes a first minor sidewall, a second minor sidewall, a first major sidewall, and a second major sidewall connected to one another to from the base portion;
the first side of the base portion is defined by the first minor sidewall; and
the second side of the base portion is defined by the second minor sidewall.

12. The blower assembly of claim 1, wherein:
the blower wheel has a diameter;
when viewed in the first direction, the first side of the base portion is disposed a first distance from the outer perimeter of the blower wheel in a second direction that is perpendicular to the first direction and to the first side of the base portion;
when viewed in the first direction, the second side of the base portion is disposed a second distance from the outer perimeter of the blower wheel in the second direction;
a ratio of the first distance to the diameter is 0.05 to 0.15; and
a ratio of the second distance to the diameter is 0.05 to 0.15.

13. The blower assembly of claim 12, wherein:
a maximum dimension of the first flow area in the second direction is equal to the first distance; and
a maximum dimension of the second flow area in the second direction is equal to the second distance.

14. The blower assembly of claim 13, wherein the first flow area and the second flow area are each circle segment shaped.

15. The blower assembly of claim 1, further comprising a blower housing in which the blower and air funnel are at least partially arranged, wherein:
the blower housing includes a scroll portion and a branch portion that extends tangentially from the scroll portion; and
the first side of the base portion of the air funnel is disposed adjacent to a scroll exit region of the blower housing at which the branch portion extends from the scroll portion.

16. The blower assembly of claim 15, wherein the blower and the air funnel are at least partially housed within the scroll portion of the blower housing.

17. The blower assembly of claim 1, wherein the base portion of the air filter defines a funnel inflow opening via which air is flowable into an inner space of the air funnel.

18. A heating, ventilation, and air conditioning (HVAC) module, comprising the blower assembly of claim 1.

19. The HVAC module of claim 18, further comprising a valve assembly connected to the valve assembly and in fluid communication with the blower assembly, wherein the valve assembly includes a filter through which air is flowable into the air funnel.

20. The HVAC module of claim 19, wherein a length of the base portion of the in a second direction that is perpendicular to the first direction and to the first side of the base portion is less than a length of the filter in the second direction.
